(19) United States
(12) Patent Application Publication
(10) Pub. No.: US 2011/0253061 A1
(43) Pub. Date: Oct. 20, 2011

(54) Toy, treat and catnip dispenser

(76) Inventor: Michael Joseph Newman, Sherman Oaks, CA (US)

(21) Appl. No.: 13/066,402

(22) Filed: Apr. 14, 2011

Related U.S. Application Data
(60) Provisional application No. 61/342,699, filed on Apr. 19, 2010.

(51) Int. Cl. A01K 29/00

(52) U.S. Cl. 119/707; 119/711

(57) ABSTRACT

A toy with catnip and pet treat dispensers and method for using are disclosed. The catnip dispenser, the third center wall, contains four small circular openings in the enclosure from which the catnip can either exit or be smelled. The treat dispenser, the first center wall, contains a ¾ inch circular opening in the enclosure from which random amounts of pet treats filter out upon exiting from a container enclosed by an interior wall with a ¾ inch circular opening opposite the first center treat dispenser wall. The pet is encouraged to roll the toy. The forward, backward and sideward rolling motion of the catnip dispenser and treat dispenser causes it to release catnip and/or pet treats through the openings at the bottom of the dispenser walls. The catnip and/or pet treats roll out the openings, encouraging the pet to further interact with the dispensers for fun and exercise.

I am claiming the benefit of the filing date of provisional application No. 61/342,699 filed on Apr. 19, 2010.

### BACKGROUND OF THE INVENTION

The present invention generally relates to a toy dispensing catnip and treats for household pets and, more specifically, to a catnip and treat dispensing product that provides fun and exercise for cats or small dogs.

Felines, canines and other domestic pets are often bored and lack positive mental and physical challenges.

As can be seen, there is a need for a toy that provides both fun and exercise for pets.

### SUMMARY OF THE INVENTION

In one aspect of the present invention, a toy and catnip dispenser and treat dispenser comprising: a central enclosure having four center walls fastened by two 3 inch diameter circle shaped outer wheel side walls, each secured by an additional semi-circle shaped side wheel wall, and an interior wall with a centered ¾ inch circular opening; in the first center outer wall of the enclosure is a ¾ inch centered circular opening diagonally opposite the interior wall, said first center outer wall to function as treat dispenser; the treat container consists of the area between the third center outer wall and interior wall, said container will filter treats from containment area behind interior wall through said interior wall's circular opening through interior space behind first center outer wall; the third center outer wall of the enclosure contains four ⅛ inch circular openings, said outer wall being in a position opposite first center outer wall, said third center outer wall to function as catnip dispenser; the catnip container consists of the area between the third center outer wall and interior wall, said container will contain provided catnip filled teabag, said container will filter catnip scent for feline enjoyment and release catnip particles through the four ⅛ inch circular openings in third center outer wall; two circle shaped outer wheel side walls bind four center outer walls to enable forward and backward rolling movement, said outer wheel walls will rotate center walls to bottom positions which upon positions will dispense pet treats from first center outer wall treat container and catnip aroma and catnip particles from third center outer wall catnip container; each additional semi-circle shaped side wheel wall binds each circular outer wheel to enable sideward rolling movement.

In another aspect of the present invention, a method for engaging a pet in exercise and fun activity comprising: placing the provided catnip filled teabag and/or pet treats in designated containers; rolling the toy dispenses catnip aroma and particles from catnip container and/or pet treats from treat container; and providing the catnip and/or pet treats to the pet.

These and other features, aspects and advantages of the present invention will become better understood with reference to the following drawings, description and claims.

### BRIEF DESCRIPTION OF THE DRAWINGS

FIG. 1 is an exploded view of the unassembled device components according to an embodiment of the present invention.

FIG. 2 is an assembly diagram perspective view of the device according to an embodiment of the present invention. FIG. 3 is a ¾ side perspective view of the assembled device according to an embodiment of the present invention.

FIG. 4 is a ¾ side perspective view of the assembled device according to an embodiment of the present invention.

FIG. 5 is an illustration of the method for using the pet treat dispenser according to an embodiment of the present invention.

FIG. 6 is an illustration of the method for using the catnip dispenser according to an embodiment of the present invention.

FIG. 7 is a side perspective view of the device according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Broadly, an embodiment of the present invention generally relates to a pet toy and catnip and/or pet treat dispenser that engages a pet, such as a canine, a feline or a ferret, in an interactive fashion.

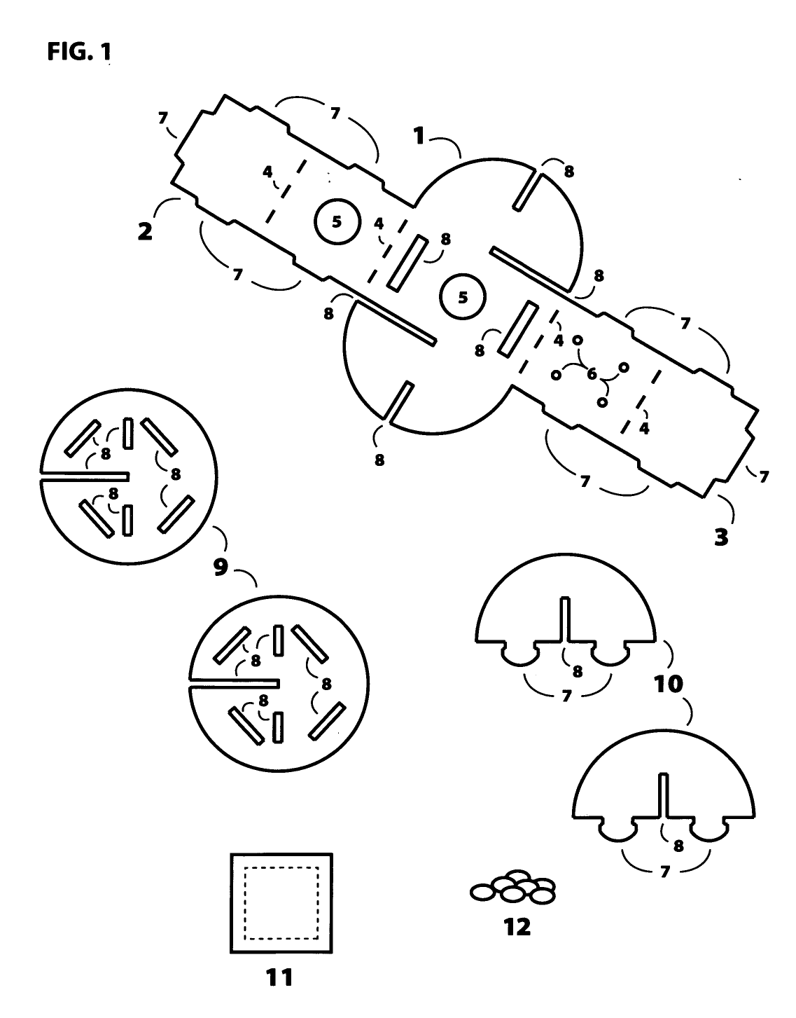

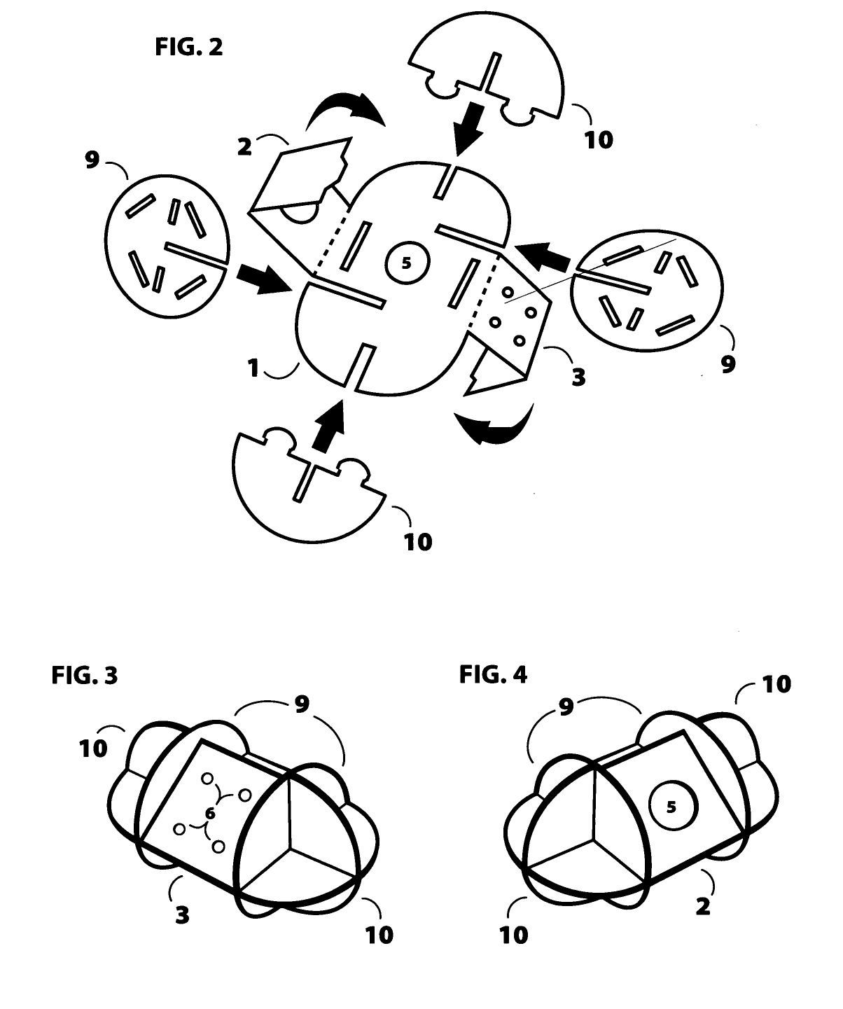

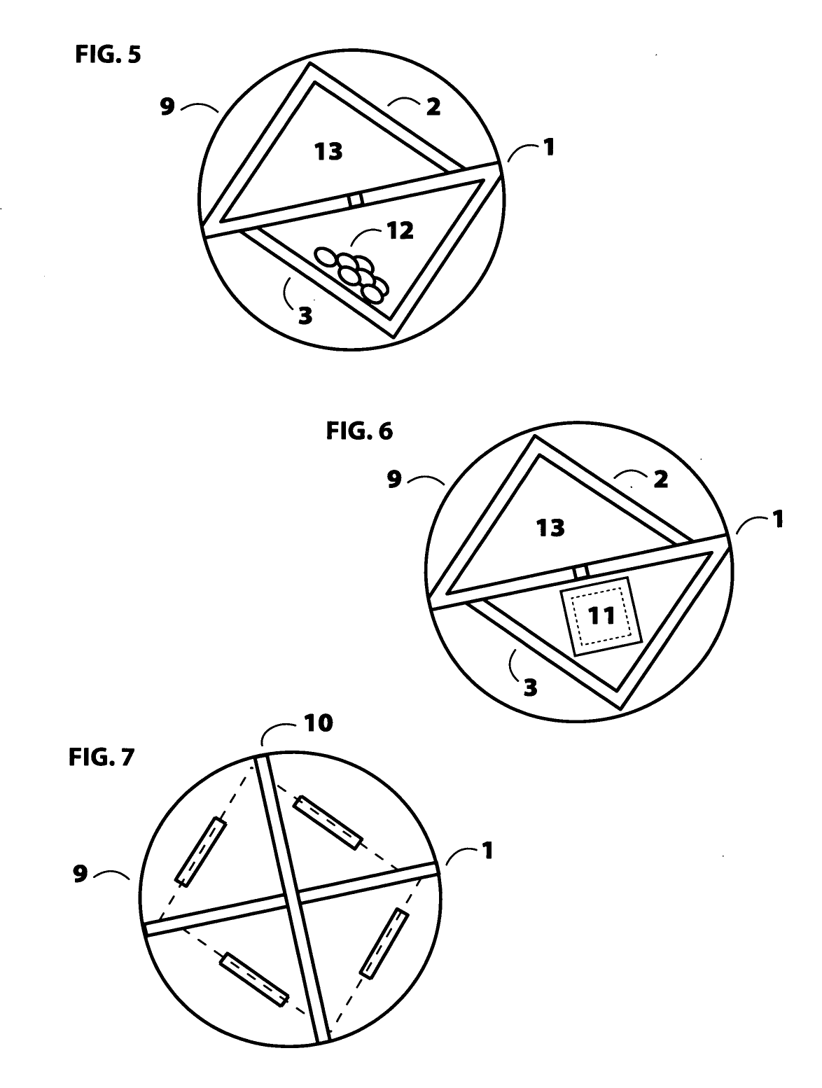

Embodiments of the present invention are illustrated in FIGS. 1-7.

The unassembled device components made from cardboard or similar thin, flexible material 1, 9, 10 is a device configured and designed to allow a provided catnip filled teabag 11 and pet treats 12 to be dispensed based on rolling movement once the scored pieces 1, 9, 10 are assembled to form the device 14. The outer structure 1 is the frame of the device 14. Scoring 4 allows the outer structure's 1 container walls 2, 3 to fold to form the outer center walls 2, 3 which will be secured by tabs 7 into slots 8.

The tabs 7 and slots 8 of the outer structures 9, 10 connect to form the catnip container dispensing wall 3, treat container dispensing wall 2, as well as outer wheel halves 9, 10 without glue, adhesives or fasteners. The outer wheel walls 9, 10 provide support for the container 1 and because of their wheel shape allow forward and backward rolling movement, resulting in pet treats to dispense from treat container dispensing wall 2 opening 5 and catnip to dispense from catnip container dispensing wall's 3 four circular openings 6. The interior treat container 13 will store provided catnip filled teabag 11 and/or consumer supplied pet treats 12. Movement of assembled device 14 will shift treats 12 in treat container 13 thereby slowly dispensing a random amount of treats 12 from treat container 13 through an empty interior opposite the container 13 and out treat container dispensing wall 2 opening 5. Upon placing provided catnip filled teabag in catnip container 13 movement will dispense catnip particles and catnip aroma from catnip container dispensing wall 3 openings 6.

105 The method for assembling the invention is detailed in FIG. 2 on page 2 of the invention drawings. The outer structure's two center walls 2, 3 are folded along scoring 4 at 45 degree angles to form center treat container dispensing wall 2 and catnip container dispensing wall 3. The center walls 2, 3 connect by inserting tabs 7 into the corresponding slots 8 to form center walls of device and 110 the catnip container and treat container 13. The outer wheel walls 9 connect by outer structure slots 8 and outer structure 1 slots 8.

To make this invention one needs the outer structures 1, 9, 10, provided catnip filled teabag 11 or any consumer supplied catnip pouch and pet treats 12. These elements are connected to produce the pet treat and catnip rolling machine 14 as shown in the invention drawings.

One would use the invention by filling the treat and catnip container 13 with pet treats 12 and/or provided catnip filled teabag 11 and placing the assembled pet treat and catnip rolling machine 14 on the ground. The individual would then train a pet to roll the device 14, causing movement, resulting in pet treats 12 dispensing from treat container dispensing wall 2 opening 5 and/or catnip 11 particles to dispense from catnip container dispensing wall 3 openings 6. Optionally one could roll the assembled device 14 if the pet was unable, unwilling or not there to participate.

It should be understood, of course, that the foregoing relates to exemplary embodiments of the invention and that modifications may be made without departing from the spirit and scope of the invention as set forth in the following claims.

We claim:

1. A toy dispensing catnip and pet treats comprising:
a central enclosure having four outer center walls, two circular shaped outer wheel walls, each secured by an additional semi-circle shaped outer side wheel wall;
a treat container enclosed by the first center wall of the enclosure, said center wall contains a circular opening, said opening to function as the treat dispenser after pet treats are released from behind interior wall with circular opening;
a catnip container enclosed by the third center wall of the enclosure, said center wall contains four circular openings, said openings to function as the catnip dispenser;
two circular shaped side walls fastened to four center walls interior of central enclosure in a manner that directs forward and backward rolling movement of the enclosure thereby dispensing catnip or pet treats from catnip dispenser and treat dispenser through opening in the bottom side of the first wall and openings in the bottom side of the third wall of the enclosure; and
two semi-circle shaped side wheel walls, each said wall will fasten to each circular shaped side wall of the enclosure in a manner that directs sideward movement of the enclosure.

2. A method for engaging a pet in exercise and fun activity comprising:
placing catnip into an enclosure;
placing treats into an enclosure;
rolling the toy to release catnip from the catnip dispenser;
rolling the toy to release treats from the treat dispenser;
rolling the toy to watch the spinning and rotating pinwheel-like movement;
rubbing toy's smooth sides and edges provide physical stimulation, especially for felines;
nosing or pawing the toy to move forward, backward, or sideward engages a pet in exercise as well as entertainment;
providing the catnip to the pet; and
providing the treats to the pet.
